(19) United States
(12) Patent Application Publication
(10) Pub. No.: US 2016/0245345 A1
(43) Pub. Date: Aug. 25, 2016

(54) Electromagnetic Clutch And Compressor

(71) Applicant: SANDEN HOLDINGS CORPORATION, Isesaki-shi, Gunma (JP)

(72) Inventors: Akihiro MIKI, Isesaki-shi, Gunma (JP); Tomonori MATSUMURA, Isesaki-shi, Gunma (JP)

(21) Appl. No.: 15/027,661

(22) PCT Filed: Oct. 8, 2013
(86) PCT No.: PCT/JP2013/077387

§ 371 Date: Apr. 6, 2016

(51) Int. Cl. F16D 27/14; F16D 27/06

(52) U.S. Cl. CPC F16D 27/14; F16D 27/06; F16D 2121/20

(57) ABSTRACT

To provide an electromagnetic clutch that prevents an armature from being reattracted to a rotor after a bridge wire is cut. Provided is an electromagnetic clutch 10 provided with a power interruption device 50 that forcibly interrupts power transmission to an electromagnetic coil 42. The power interruption device 50 includes a thermally-actuated member 51 attached to a rotor 21 and displaced at over a predetermined temperature, and a bridge wire 52 extending as a part of ground wire of the electromagnetic coil 42 and stretched across an area where the thermally-actuated member moves along with rotation of the rotor 21. The thermally-actuated member 51 is displaced to collide with and cut the bridge wire. The bridge wire 52 has a cutting region apart from a position where the displaced thermally-actuated member 51 collides with the bridge wire 52.

### TECHNICAL FIELD

The present invention relates to an electromagnetic clutch and more particularly to an electromagnetic clutch suitable for intermittently transmitting power of an engine or motor of a vehicle to an in-vehicle driven device (for example, a compressor of an air conditioner for use in a vehicle).

### BACKGROUND ART

As this type of electromagnetic clutches, for example, the one disclosed in Patent Document 1 has been known. The electromagnetic clutch disclosed in Patent Document 1 is provided with an electromagnetic coil unit including a rotor driven with power from a power source, an armature provided opposite to the rotor and connected to a rotation shaft of a driven device, and a bobbin around which an electromagnetic coil is wound. The electromagnetic coil unit causes magnetic attraction between the rotor and the armature in response to electric power supply. The electromagnetic clutch is further provided with a thermally-actuated member that can be displaced toward the electromagnetic coil by sensing the temperature. The member is installed in an electromagnetic unit of the rotor. If heat is generated due to relative sliding between friction surfaces of the rotor and the armature, and the temperature exceeds a predetermined level, the thermally-actuated member attached to the grounded rotor serves to cut a wire extending as a part of the electromagnetic coil in a bridge shape and stretched across an area where the thermally-actuated member moves along with the rotor rotation. Thus, electric power supply to the electromagnetic coil is forcibly interrupted.

### REFERENCE DOCUMENT LIST

### Patent Document

Patent Document 1: JP H01-210626 A

### SUMMARY OF THE INVENTION

### Problems to be Solved by the Invention

Note that the bridge wire stretched across the area where the thermally-actuated member moves along with the rotor rotation is formed on the ground side of the electromagnetic coil. Accordingly, if the thermally-actuated member cuts the bridge wire, no excessive current flows therein.

However, the electromagnetic clutch has a possibility that, after the bridge wire is cut, the tip end of wire remaining on the side (positive side) opposite to the ground side would contact the rotating thermally-actuated member or rotor and be grounded thereby. As a result, even if the bridge wire is cut, current flows in the electromagnetic coil and the armature is reattracted to the rotor.

The present invention has been made in view of the above circumstances and an object of the present invention is to provide an electromagnetic clutch that can prevent an armature from being reattracted to a rotor after a bridge wire is cut.

### Means for Solving the Problems

In order to achieve the above object, the present invention provides an electromagnetic clutch, including: a rotor rotated with a power of a driving source; an armature provided opposite to the rotor and connected to a rotation shaft of a driven device; an electromagnetic coil unit that includes an electromagnetic coil, and causes magnetic attraction between the rotor and the armature upon electric power supply to the electromagnetic coil; and a power interruption device that forcibly interrupts electric power supply to the electromagnetic coil. In the electromagnetic clutch, the power interruption device includes: a thermally-actuated member attached to the rotor and displaced at over a predetermined temperature; and a bridge wire stretched across an area where the thermally-actuated member moves along with rotation of the rotor and extending as a part of ground wire of the electromagnetic coil. The power interruption device cuts the bridge wire such that the thermally-actuated member is displaced to collide with the bridge wire, and the bridge wire has a cutting region apart from a position where the displaced thermally-actuated member collides with the bridge wire.

### Effects of the Invention

In the above electromagnetic clutch, the bridge wire extending as a part of ground wire of the electromagnetic coil is cut at the cutting region apart from a position where the displaced thermally-actuated member collides with the bridge wire. Owing to this structure, after the bridge wire is cut, the tip end of the wire remaining on the side (positive side) opposite to the ground side can be kept from contacting the rotor or thermally-actuated member that are generally grounded. This makes it possible to prevent current from into the electromagnetic coil after the bridge wire is cut and thus prevent the armature from being reattracted to the rotor after the cutting of the bridge wire.

### BRIEF DESCRIPTION OF THE DRAWINGS

FIG. 1 is a sectional view of an electromagnetic clutch according to the present invention.

FIG. 2 is a front view of a rotor unit.

FIG. 3 is a sectional view taken along the line A-O-A of FIG. 2.

FIG. 4 is a sectional view of an armature unit.

FIG. 5 is a sectional view of an electromagnetic coil unit.

FIG. 6 is a sectional view of a bobbin in the electromagnetic coil unit.

FIG. 7 is an enlarged view of a bridge wire viewed from the arrow A of FIG. 5.

FIG. 8 is a view of the bridge wire viewed from the arrow B of FIG. 7.

FIG. 9 is a view of the bridge wire viewed from the arrow C of FIG. 7.

FIG. 10 is a sectional view taken along the line D-D of FIG. 7.

FIG. 11 is an enlarged view of a portion E of FIG. 7.

FIG. 12 is an explanatory operational view of a power interruption device under the condition that bimetal is not displaced.

FIG. 13 is an explanatory operational view of a power interruption device under the condition that bimetal is displaced beyond a predetermined distance.

FIG. 14 is a sectional view of the bimetal of FIG. 12.

FIG. 15 is a sectional view of the bimetal of FIG. 13.

### MODES FOR CARRYING OUT THE INVENTION

An embodiment of the present invention will be described hereinafter with reference to the accompanying drawings.

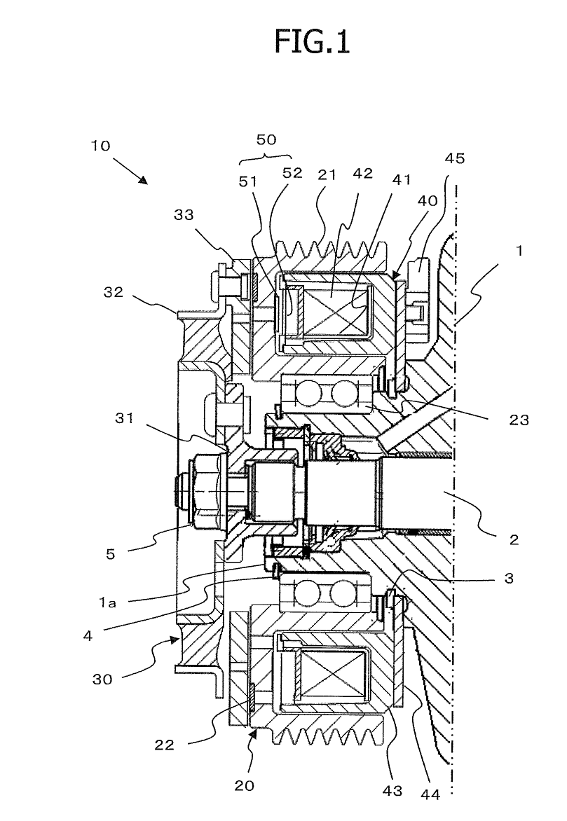

FIG. 1 shows the structure of an electromagnetic clutch according to the embodiment of the present invention.

An electromagnetic clutch 10 of this embodiment is incorporated in a compressor constituting an in-vehicle air conditioner and configured to transmit/interrupt power from a vehicle engine or motor as a driving power source to the compressor as a driven device. In other words, the electromagnetic clutch 10 switchingly transmits/interrupts power from the engine or the motor to the compressor. The compressor of the present invention is provided with the electromagnetic clutch. An embodiment of the clutch is described later. While the compressor is operated in response to power transmission from the engine or motor, the compressor stops operation in response to power interruption. The compressor of the present invention could be, for example, a swashplate type variable-displacement compressor. Note that it is possible to employ variable-displacement compressors of other types or fixed-displacement compressors of scroll type, vane type, etc.

In FIG. 1, the electromagnetic clutch 10 includes a rotor unit 20, an armature unit 30, an electromagnetic coil unit 40, and a power interruption device 50.

The rotor unit 20 is provided with a rotor 21 rotated with a power of an engine or motor, and rotatably supported to an end surface of the compressor. The rotor unit is composed of the rotor 21, a friction member 22, and a bearing 23.

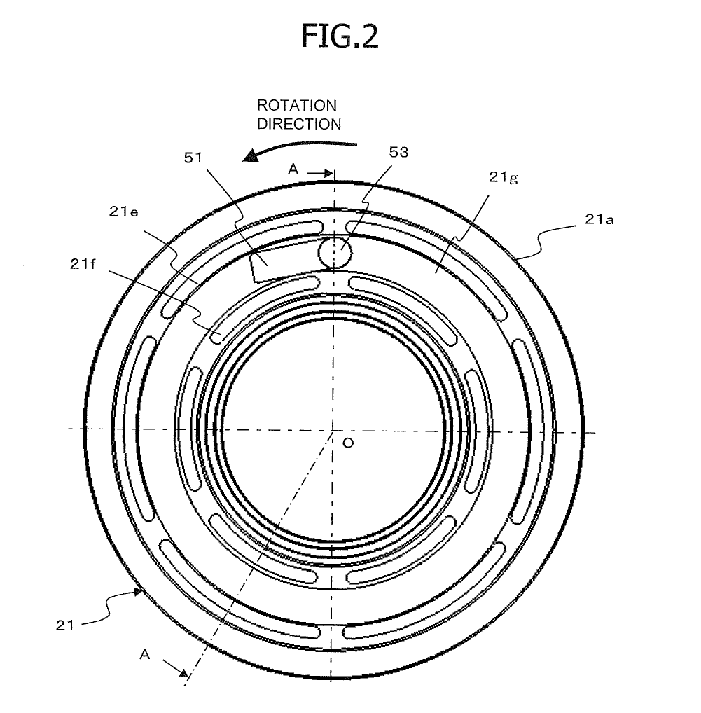

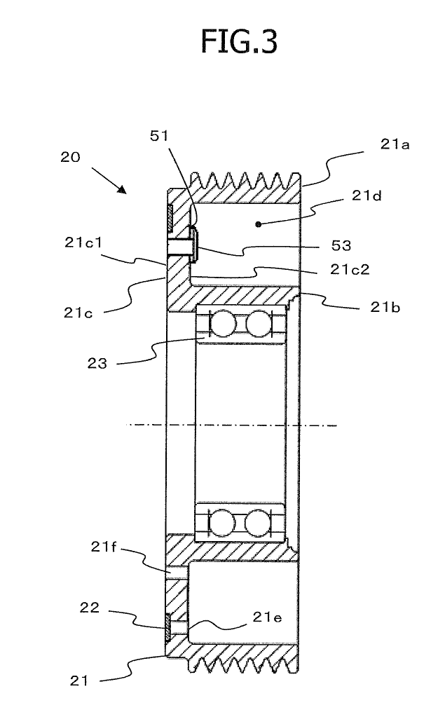

The rotor 21 has a circular shape. The inner circumference of the rotor 21 is rotatably supported to the outer circumference of a boss 1a as an end surface of a front housing 1 of the compressor by means of the bearing 23. On the outer circumference of the rotor 21, formed are grooves on which a belt for transmitting a rotational force from the engine or motor is stretched. More specifically, as shown in FIGS. 2 and 3, the rotor 21 is integrally constituted of an outer cylindrical portion 21a having the outer circumference, an inner cylindrical portion 21b having the inner circumference, and an end surface portion 21c connecting the outer cylindrical portion 21a and the inner cylindrical portion 21b. The outer cylindrical portion 21a, the inner cylindrical portion 21b, and the end surface portion 21c are formed of a ferromagnetic material (specific example: iron material). These members form a circular recess 21d that accommodates an electromagnetic coil 42 in the electromagnetic coil unit 40. Arc-shaped slits 21e and 21f are formed on the end surface portion 21c so as to divert magnetic flux generated in the electromagnetic coil 42. In addition, between the arc-shafted slits 21e and 21f in a bottom end surface portion 21c2 of the end surface portion 21c in the circular recess 21d, formed is a circular groove 21g (see FIGS. 2, 12, and 13) where a bimetal 51 of the power interruption device 50 is attached as described below. A friction surface 21c1 is defined as an end surface of the end surface portion 21c opposite to the bottom wall of the circular recess 21d. The rotor 21 is grounded although not shown.

The friction member 22 is made of a circular nonmagnetic material to increase friction coefficient and attached to the friction surface 21c1 of the rotor 21.

Discussing the structure of the bearing 23, its inner ring is positioned to the outer circumference of the boss 1a of the front housing 1 and fixed thereto with a snap ring 4. The bearing rotatably supports the rotor 21 on the outer circumference of the boss 1a as the end surface of the front housing 1.

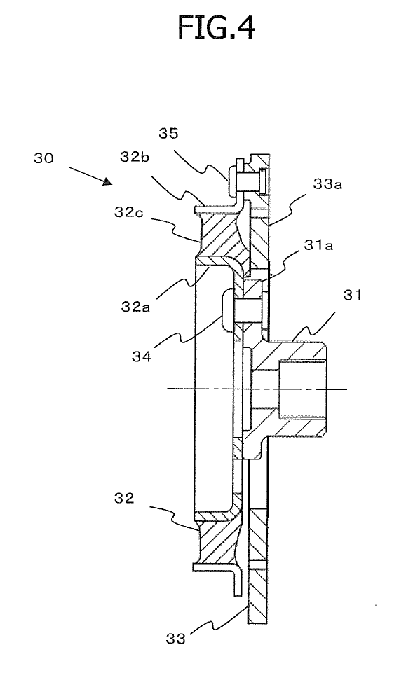

The armature unit 30 transmits/interrupts power from an engine or motor to a compressor according to the movement of the armature 33, which collides with or retracts from the rotor 21 in response to electric power supply/interruption with respect to the electromagnetic coil 42. As shown in FIG. 4, the armature unit includes a hub 31, a rubber unit 32, and the armature 33.

The hub 31 is provided with a flange portion 31a and fixed to the tip end of a rotation shaft 2 of the compressor by means of a nut 5.

The rubber unit 32 includes an inner ring 32a, an outer ring 32b, and a circular rubber 32c interposed between the inner ring 32a and the outer ring 32b and fixed to the inner ring 32a and the outer ring 32b by cure adhesion. The inner ring 32a is fixed to the flange portion 31a of the hub 31 with a rivet 34.

The armature 33 is provided opposite to the rotor 21 and connected to the rotation shaft 2 of the compressor. To be specific, the armature 33 is a circular plate member with one end surface forming a friction surface 33a, which faces the friction surface 21c1 of the rotor 21 at a predetermined interval. The armature 33 is fixed to the outer ring 32b of the rubber unit 32 with a rivet 35 and elastically supported by the circular rubber 32c. The armature 33 is formed of a ferromagnetic material (specific example: iron material). The armature 33 constitutes a magnetic circuit together with the rotor 21. When electric power is supplied to the electromagnetic coil 42, the armature is magnetically attracted to the rotor 21. Meanwhile, when magnetic attraction power is extinguished due to power interruption, the armature moves away from the rotor 21.

The electromagnetic coil unit 40 includes the electromagnetic coil 42 and generates a magnetic field in response to electric power supply to the coil to thereby cause magnetic attraction between the armature 33 and the rotor 21. The unit includes a bobbin 41, the electromagnetic coil 42 wound around the bobbin, a ring case 43 having a circular recess for accommodating the bobbin 41, an annular disc-like fixing member 44 forming the other end surface of the electromagnetic coil unit 40, and a connecting portion 45 for connecting an external power source in the vehicle and the electromagnetic coil 42.

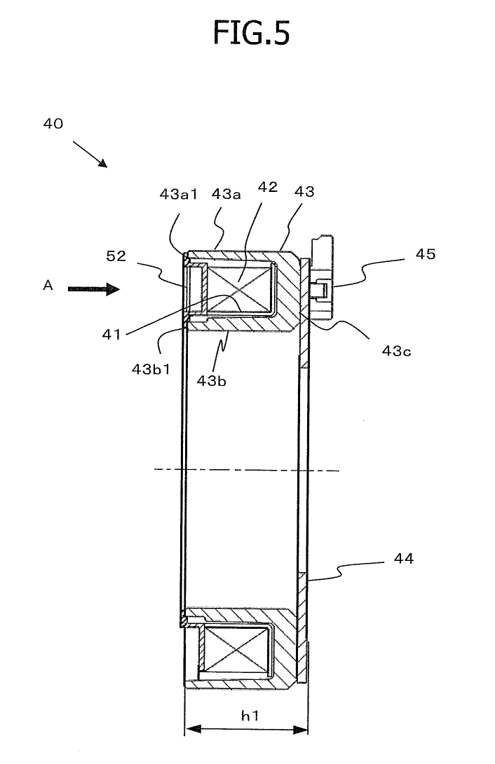

As shown in FIG. 5, the ring case 43 has a circular recess integrally formed by an outer cylindrical portion 43a, an inner cylindrical portion 43b, and an end surface portion 43c that connects the outer cylindrical portion 43a and the inner cylindrical portion 43b. The recess accommodates the bobbin 41 around which the electromagnetic coil 42 is wound. The outer cylindrical portion 43a and the inner cylindrical portion 43b are coaxial with the axial line of the rotation shaft 2 of the compressor. The end surface portion 43c is orthogonal to the axial line of the rotation shaft 2. An end surface 43a1 of the outer cylindrical portion 43a and an end surface 43b1 of the inner cylindrical portion 43b extend flush with each other and orthogonally to the axial line of the rotation shaft 2. The outer cylindrical portion 43a, the inner cylindrical portion 43b, and the end surface portion 43c are formed of a ferromagnetic material (for example, iron material) to constitute a magnetic circuit.

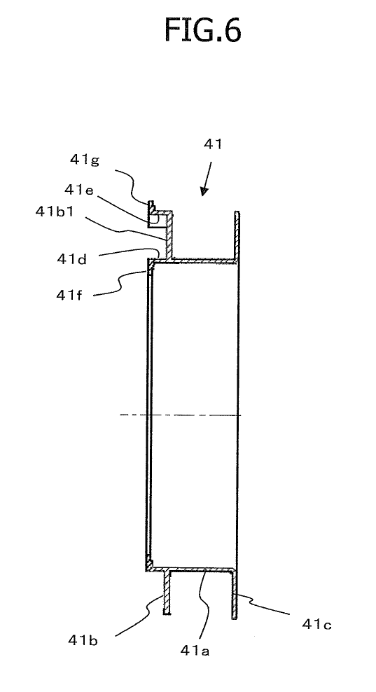

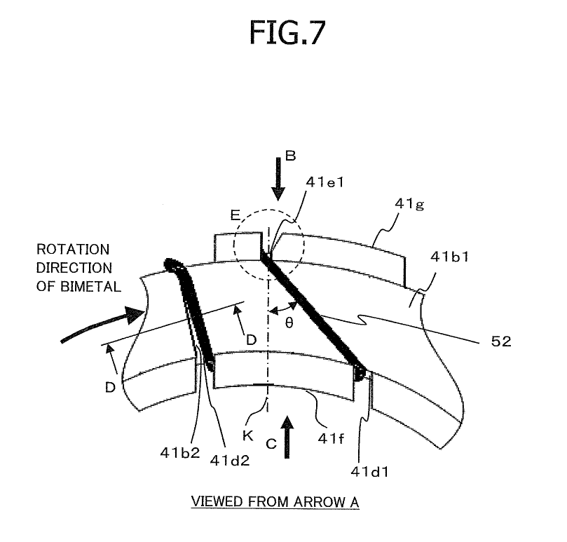

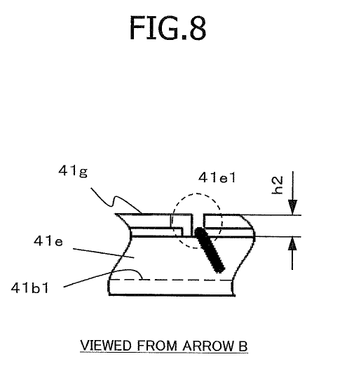

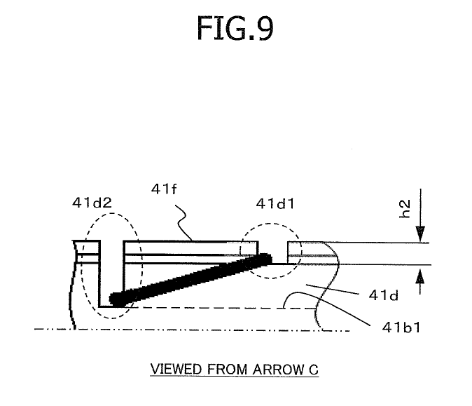

As shown in FIG. 6, the bobbin 41 includes the cylindrical portion 41a, and a first flange 41b and a second flange 41c, which extend radially outwardly from each end of the cylindrical portion 41a. The electromagnetic coil 42 is wound around an area surrounded by the flanges 41b and 41c. The bobbin 41 also has an inner wall 41d and an outer wall 41e, which extend from a proximal end and a tip end of the first flange 41b, respectively toward a bottom wall 21c2 of the circular recess 21d of the rotor 21. The inner wall 41d is formed in almost all the circumference of the proximal end of the first flange 41b. Similarly formed in almost all the circumference thereof is an inner flange 41f, which extends radially inwardly from the tip end thereof. Further, the outer wall 41e is formed only in the vicinity of a predetermined portion of the tip end of the first flange 41b (the winding end of the electromagnetic coil 42). An outer flange 41g extends radially outwardly from the tip end thereof. Referring to FIG. 8 that illustrates the structure viewed from the arrow B of FIG. 7, the outer wall 41e of the bobbin 41 has a first slit 41e1 with a predetermined distance h2 (corresponding to the thickness of the outer flange 41g) from the tip end (upper surface of the outer flange 41g). Moreover, as shown in FIG. 9 that illustrates the structure viewed from the arrow C of FIG. 7, the inner wall 41d of the bobbin 41 has a second slit 41d1 with the depth h2 (corresponding to the thickness of the inner flange 41f) that is the same as the first slit 41e1, from the tip end (upper surface of the inner flange 41f), and a third slit 41d2 extending from the tip end (upper surface of the inner flange 41f) down to a first flange surface 41b1. The bobbin 41 includes the cylindrical portion 41a, the first flange 41b, the second flange 41c, the inner wall 41d, the outer wall 41e, the inner flange 41f, and the outer flange 41g, which are integrally formed of a resin material, for example, a polyamide resin. Owing to this structure, as will be described below, a bridge wire 52 can be easily obtained using the winding end of the electromagnetic coil 42 wound around the bobbin 41.

The electromagnetic coil unit 40 is securely insulated by pouring a resin through the space between the ring case 43 and the bobbin 41 accommodated in the circular recess of the ring case 43. As shown in FIG. 5, the bobbin 41 is positioned and fixed in the circular recess of the ring case 43 such that the outer flange 41g of the bobbin 41 is positioned to the end surface 43a1 of the outer cylindrical portion 43a of the ring case 43, and the inner flange 41f is positioned to the end surface 43b1 of the inner cylindrical portion 43b of the ring case 43. The electromagnetic coil unit 40 is fixed to the end surface of the front housing 1 such that the fixing member 44 fixed to the end surface of the end surface portion 43c, which is opposite to the bottom wall of the circular recess is positioned to the end surface of the front housing 1 and fixed thereto with the snap ring 3 as shown in FIG. 1.

When heat is generated due to relative sliding between the rotor 21 and the armature 31, the power interruption device 50 forcibly interrupts electric power supply to the electromagnetic coil 42. The device is provided with thermally-actuated members, for example, the bimetal 51 and the bridge wire 52.

The bimetal 51 is provided on the rotor, and displaced toward the electromagnetic coil unit 40 if sensing the temperature higher than a predetermined level. More specifically, the bimetal 51 is formed in substantially a rectangular shape and accommodated in the circular groove 21g formed in the bottom wall 21c2 of the circular recess 21d of the rotor 21. One end thereof is fixed with a rivet 53, and the other end faces toward the rotation direction of the rotor 21. Since the bimetal 51 is accommodated and positioned in the circular groove 21g, if the bimetal 51 collides with (engaged with) and cuts the bridge wire 52, the bimetal can be prevented from tilting to the left or right relative to the rotation direction of the rotor 21 in response to the reaction force of the bridge wire 52. The bimetal 51 is preferably a snap action type that starts inverted motion at a predetermined temperature. The snap action type bimetal is hardly displaced at a temperature lower than an inverted motion temperature (temperature causing inverted motion) but largely displaced at the inverted motion temperature or higher. By utilizing the inverted motion, the bridge wire 23 is cut. In general, in a compressor for an in-vehicle air conditioner, the electromagnetic clutch 10 may increase the temperature up to 150° C. Taking the temperature into consideration, the inverted motion temperature for interrupting electric power supply to the electromagnetic coil 42 is set to 180° C. to 190° C. Here, the bimetal 51 is fixed with the rivet 53 but any other fixing member such as a bolt is applicable.

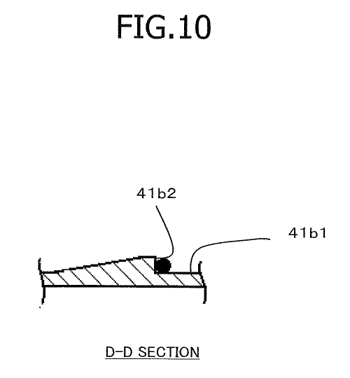

The bridge wire 52 is a part of ground wire of the electromagnetic coil 42. The bridge wire is, for example, obtained using the winding end of the electromagnetic coil 42 wound around the bobbin 41. The bridge wire 52 is inserted into the circular recess 21d of the rotor 21, and stretched over one end surface of the rotor unit 20 opposite to the bottom wall 21c2 thereof so as to cross an area where the bimetal 51 moves along with the rotation of the rotor 21 (movement area of the bimetal 51) and also to collide with (engage with) the bimetal 51 displaced beyond a predetermined distance. More specifically, as shown in FIGS. 7 to 11, the winding end of the electromagnetic coil 42 wound around the bobbin 41 is inserted into the first slit 41e1 from one side (radially outer portion of the bobbin 41) of the outer wall 41e, the other side of which faces the inner wall 41d. The inserted wire crosses a space surrounded by the outer wall 41e, the inner wall 41d, and the first flange 41b. Then, the wire is inserted into the second slit 41d1, and positioned and supported on the end surfaces of both the slits 41e1 and 41d1. Subsequently, the wire is inserted into the third slit 41d2 of the inner wall 21d from one side (radially inner portion of the bobbin 41) of the inner wall 21d, the other side of which faces the outer wall 41e. The inserted wire is guided along a guide wall 41b2 (see FIG. 10) formed on the surface 41b1 of the first flange 41b toward the outer wall 41e over the surface 41b1 of the first flange 41b. Then, the wire is routed outwardly in the radial direction of the bobbin 41. In this way, the bridge wire 52 extends over the first flange 41b and is stretched between the outer wall 41e and the inner wall 41d.

The inner flange 41f and the outer flange 41g are formed at the same height from the surface 41b1 of the first flange 41b. The first slit 41e1 and the second slit 41d1 are formed at the same depth, i.e., depth h2. Thus, the bridge wire 52 is stretched in parallel to the surface 41b1 of the first flange 41b at a predetermined height. By controlling the following: the height h1 from the end surface (reference surface) of the fixing member 44 near the front housing 1 to the end surfaces 43a1 and 43b1 of the outer cylindrical portion and the inner cylindrical portion of the ring case 43, respectively; the depth h2 from the end surfaces of the outer wall 41e and the inner wall 41d to the end surfaces of the first slit 41e1 and the second slit 41d1, respectively; and the thickness of each of the inner flange 41f and the outer flange 41g, the bridge wire 52 can be precisely positioned in the axial direction of the electromagnetic clutch. Similarly, the surface 41b1 of the first flange can be precisely positioned.

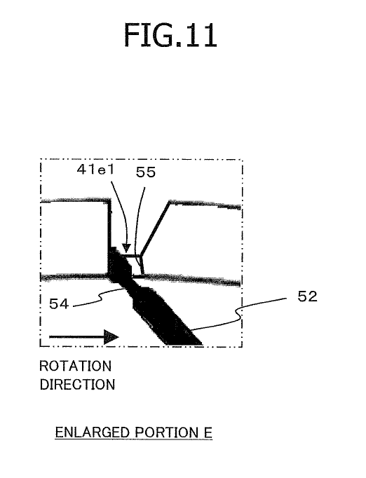

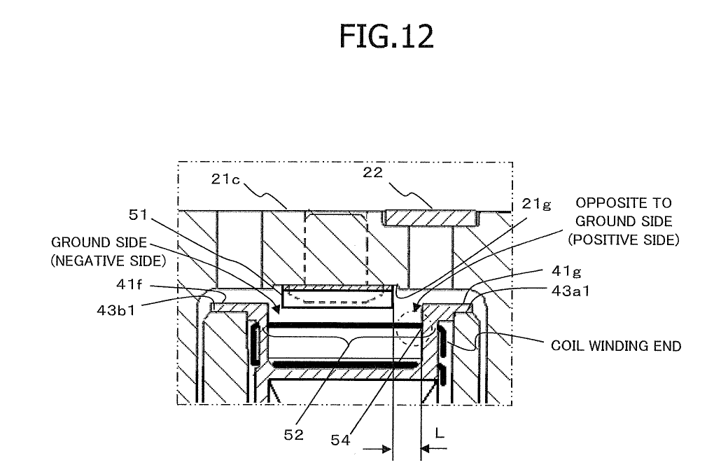

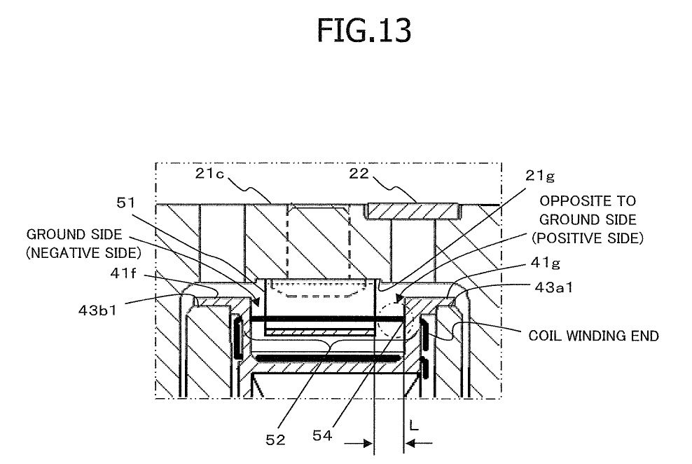

As shown in FIGS. 12 and 13, a cutting region 54 of the bridge wire 52 is defined apart from the position where the displaced bimetal 51 collides with the bridge wire 52 by a predetermined distance L and also defined on the side (positive side/coil side) of the bridge wire 52 opposite to the ground side (i.e., negative side). In this embodiment, as shown in FIG. 11, an area of the cutting region 54 of the bridge wire 52 is set smaller in section than the other areas of the bridge wire 52. The distance L is preferably 1 mm or more, for example.

Here, if the bridge wire 52 is stretched such that the wire would collide with the bimetal 51 face to face, the following situation is conceivable. That is, the bridge wire 52 collides with the whole bimetal 51 at a time, and the bimetal 51 is largely displaced and fails to cut the bridge wire 52. To prevent such a situation, in this embodiment, the bridge wire 52 is inclined so that the cutting region could collide with the bimetal 51 ahead of the ground side. More specifically, as shown in FIG. 7, the bridge wire 52 is included at an angle θ relative to a line K passing the center in the radial direction of the bobbin 41 and the first slit 41e1 so that the cutting region (first slit 41e1 side) could get closer to the bimetal 51. The angle θ is set to, for example, 20° to 60°.

In this embodiment, a support portion 55 (see FIG. 11) is formed using the end surface of the first slit 41e1. The support portion supports the cutting region 54 of the bridge wire 52 and its vicinities reversely to the rotation direction of the bimetal when the bimetal 51 collides with the bridge wire 52. The first slit 41e1 is slightly wider than the outer diameter of the wire as shown in FIG. 11. Thus, if the displaced bimetal 51 collides with the bridge wire 52, the cutting region 54 is shifted along the rotation direction of the bimetal 51. At this time, the cutting wire 54 is made closer to the radially inner portion of the bobbin 41 than the first slit 41e, i.e., closer to the bimetal 51 than the support portion 55.

Next, a brief description is given of how the thus-configured electromagnetic clutch 10 transmits/interrupts power to the compressor.

Discuss first an operation of transmitting/interrupting power under a normal state in which the power interruption device is not operating. In this state, an air conditioner control device in the vehicle makes control to supply/interrupt electric power to the electromagnetic coil unit 40.

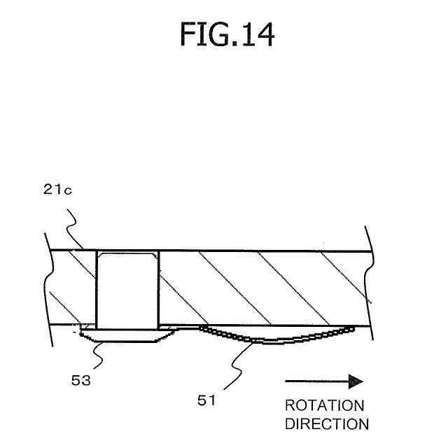

First, a rotational force from the engine rotates the rotor 21. If electric power is supplied to the electromagnetic coil 42 in this state, the electromagnetic coil unit 40 magnetizes the rotor 21. The generated magnetic force makes the friction surface 33a of the armature 33 attracted to the friction surface 21c of the rotor 21. The frictional force generated therebetween rotates the armature 33 in sync with the rotor 21. The rotational force of the armature 33 is transmitted to the rotation shaft 2 by way of the rubber unit 32 and the hub 31. The compressor starts operating along with the rotation of the rotor 21. In contrast, if the air conditioner control device in the vehicle interrupts electric power supply to the electromagnetic coil 42 of the coil unit 40, the rotor 21 is demagnetized, and the restoring force of the rubber 32c makes the friction surface 33a of the armature 33 retract from the friction surface 21c1 of the rotor 21. No rotational force of the rotor 21 is transmitted to the armature 33, and the rotation shaft 2 stops rotating to terminate the operation of the compressor. In such a state that electric power is supplied to the electromagnetic coil 42, the rotor 21 is excited, the magnetic force makes the friction surface 33a of the armature 33 attracted to the friction surface 21c1 of the rotor 21, and the armature 33 is rotated in sync with the rotor 21, the temperature of the end surface portion 21c of the rotor 21 does not reach the inverted motion temperature of the bimetal 51. As shown in FIGS. 12 and 14, the bimetal 51 passes above the bridge wire 52 without colliding with the bridge wire 52.

Discussing next the case where the power interruption device is operating, if an excessive torque much larger than a normal value acts on the rotation shaft 2 due to, for example, damaged inner parts of the compressor under the state shown in FIGS. 12 and 14, relative sliding occurs between the friction surface 21c1 of the rotor 21 and the friction surface 33a of the armature 33. The temperature of the end surface portion 21c of the rotor 21 suddenly rises due to heat generated between the friction surfaces.

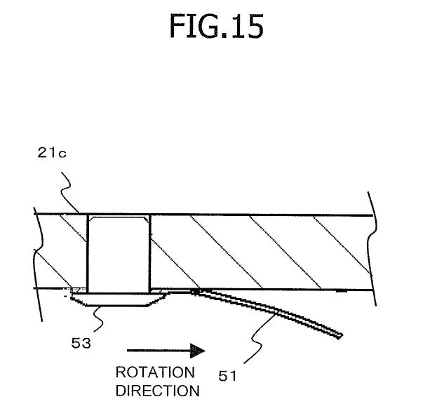

Following the sudden temperature rise in the end surface portion 21c, the other end of the bimetal 51 (opposite side to one end fixed with the rivet 53) is gradually displaced toward the electromagnetic coil unit 40. If the temperature exceeds the inverted motion temperature, as shown in FIGS. 13 and 15, the other end of the bimetal 51 is largely displaced beyond a predetermined distance and then collides with (engaged with) the bridge wire 52. An excessive tension acts on the cutting region 54 formed on the first slit 41e1 side to thereby cut the bridge wire 52 at the cutting region 54. Consequently, it is possible to forcibly interrupt electric power supply to the electromagnetic coil 42, retract the friction surface 33a of the armature 33 from the friction surface 21c1 of the rotor 21, keep the engine from receiving an excessive load, protect the belt, and ensure driving safety of the vehicle.

In the thus-structured electromagnetic clutch 10, the cutting region 54 is defined apart by a predetermined distance L from a position where the displaced bimetal 51 collides with the bridge wire 52 and also defined on the side opposite to the ground side of the bridge wire 52. Accordingly, after the bridge wire 52 is cut, the tip end of wire (piece) remaining on the side opposite to the ground side never contacts the grounded rotor 21 or bimetal 51. In other words, no current flows into the electromagnetic coil after the bridge wire is cut. Thus, the armature is never reattracted to the rotor after the cutting of the bridge wire.

Since the cutting region 54 is formed near the first slit 41e1, the tip end of the piece of the bridge wire 52 opposite to the ground side hardly moves. Further, the resin-made outer wall 41e having the first slit 41e1 secures insulation against the tip end of the piece of the bridge wire 52 on the side opposite to the ground side.

In this embodiment, the cutting region 54 of the bridge wire 52 is set smaller in section than the other regions. When the bridge wire 52 is pulled upon collision with the bimetal 51, the bridge wire 52 is easily cut at the cutting region 54 to thereby realize reliable cutting. This makes it possible to inhibit the bimetal 51 from being largely displaced upon collision with the bridge wire 52 and accordingly avoid any damage of the bimetal 51.

Further, in this embodiment, the bridge wire 52 is placed at such angle as makes the cutting region 54 (first slit 41e1 side) collide with against the bimetal 51 ahead of the ground side. As a result, the edge of the bimetal 51 on the cutting region 54 side collides with the bridge wire 52 and thus, the bimetal 51 itself is less displaced and its tip end easily slips under the bridge wire 52. In addition, the tension can securely act on the cutting region 54 on the side (positive side) opposite to the ground side.

In this embodiment, the support portion 55 is formed to support the cutting region 54 and its vicinities of the bridge wire 52 reversely to the rotation direction upon collision of the bimetal 51 against the bridge wire 52. The tension securely acts on the cutting region 54 on the support portion 55 as fulcrum and thus, the wire can be cut at the cutting region 54 more reliably. This embodiment shows an example the cutting region 54 is defined closer to the bimetal 51 than the support portion 55. However, the present invention is not limited thereto. The cutting region 54 may collide with the support portion 55.

While the bimetal is used as a thermally-actuated member in this embodiment, other thermally-actuated members such as shape memory alloy are applicable. Although the bridge wire 52 is formed using the winding end of the coil wound around the bobbin 41 in this embodiment, other types of wire are applicable with no limitation in place of the coil wound around the bobbin 41.

Further, the above embodiment shows an example where the electromagnetic clutch is attached to the compressor used for the in-vehicle air conditioner, but the electromagnetic clutch of the present invention can be used for other purposes.

Moreover, in this embodiment, the cutting region 54 is formed apart from a position where the displaced bimetal 51 collides with the bridge wire 52, on the side opposite to the ground side of the bridge wire 52. However, the present invention is not limited thereto. The cutting region 54 has only to be apart from a position where the displaced bimetal 51 collides with the bridge wire 52. Accordingly, even if the cutting region 54 is formed on the side opposite to the ground side of the bridge wire 52, after the bridge wire 52 is cut, the tip end of wire (piece) remaining on the side (positive side) opposite to the ground side out of the cut bridge wire 52 can be prevented from contacting the grounded rotor 21 or thermally-actuated member 51. This structure inhibits the armature from being reattracted to the rotor after the bridge wire is cut. In this case, the bridge wire 52 may be coated with an insulating material to achieve insulation against the thermally-actuated member 51 even if portions other than the tip end of the wire (piece) remaining on the side opposite to the ground side contacts the member.

The preferred embodiments of the present invention have been discussed above, but the present invention is not limited to the above embodiment and various modifications and changes are applicable within the technical scope of the present invention.

Note that the basic configuration of the electromagnetic clutch according to the present invention is as follows. That is, the electromagnetic clutch includes: a rotor rotated with power of a driving source; an armature provided opposite to the rotor and connected to a rotation shaft of the driven device; an electromagnetic coil unit that includes an electromagnetic coil, and causes magnetic attraction between the rotor and the armature upon electric power supply to the electromagnetic coil; and a power interruption device that forcibly interrupts electric power supply to the electromagnetic coil. In the clutch, the power interruption device includes: a thermally-actuated member attached to the rotor, and displaced at over a predetermined temperature; and a bridge wire stretched across an area where the thermally-actuated member moves along with rotation of the rotor and extending as a part of ground wire of the electromagnetic coil. The device cuts the bridge wire such that the thermally-actuated member is displaced to collide with the bridge wire. The bridge wire has a cutting region apart from a position where the displaced thermally-actuated member collides with the bridge wire and also on the side opposite to the ground side of the bridge wire. The electromagnetic clutch having the above basic configuration can be expressed as follows. That is, the electromagnetic clutch includes: a rotor rotated with power of a driving source; an armature provided opposite to the rotor and connected to a rotation shaft of the driven device; an electromagnetic coil unit that includes an electromagnetic coil, and causes magnetic attraction between the rotor and the armature upon electric power supply to the electromagnetic coil; and a power interruption device that forcibly interrupts electric power supply to the electromagnetic coil. In the clutch, a thermally-actuated member displaced at over a predetermined temperature is attached to the rotor, and ground wire of the electromagnetic coil serves as a bridge wire that is stretched across an area where the thermally-actuated member moves along with rotation of the rotor. The displaced thermally-actuated member collides with the bridge wire and thereby cuts the bridge wire. The bridge wire is cut in a position closer to the side opposite to the ground side relative to a position where the displaced thermally-actuated member collides with the bridge wire.

### REFERENCE SYMBOL LIST

10 . . . Electromagnetic clutch
21 . . . Rotor
33 . . . Armature
40 . . . Electromagnetic coil unit
42 . . . Electromagnetic coil
50 . . . Power interruption device
51 . . . Bimetal (thermally-actuated member)
52 . . . Bridge wire
54 . . . Cutting region
55 . . . Support portion
2 . . . Rotation shaft of driven device (compressor)

1. An electromagnetic clutch, comprising:
a rotor rotated with a power of a driving source;
an armature provided opposite to the rotor and connected to a rotation shaft of a driven device;
an electromagnetic coil unit that includes an electromagnetic coil, and causes magnetic attraction between the rotor and the armature upon electric power supply to the electromagnetic coil; and
a power interruption device that forcibly interrupts power supply to the electromagnetic coil,
wherein the power interruption device includes:
a thermally-actuated member attached to the rotor, and displaced at over a predetermined temperature; and
a bridge wire stretched across an area where the thermally-actuated member moves along with rotation of the rotor and extending as a part of ground wire of the electromagnetic coil,
wherein the displaced thermally-actuated member collides with the bridge wire to cut the bridge wire, and
wherein the bridge wire has a cutting region apart from a position where the displaced thermally-actuated member collides with the bridge wire.

2. The electromagnetic clutch according to claim 1, wherein a position apart from the position where the displaced thermally-actuated member collides with the bridge wire is on a side opposite to a ground side of the bridge wire.

3. The electromagnetic clutch according to claim 1, wherein the cutting region of the bridge wire is set smaller in section than the other regions of the bridge wire.

4. The electromagnetic clutch according to claim 1, wherein the bridge wire is placed at such an angle as makes the cutting regions collide with the thermally-actuated member ahead of the ground side.

5. The electromagnetic clutch according to claim 1, further comprising a support portion that supports the cutting region and vicinities of the bridge wire reversely to a rotation direction when the thermally-actuated member collides with the bridge wire.

6. A compressor provided with the electromagnetic clutch according to claim 1.
